(19) United States
(12) Patent Application Publication
(10) Pub. No.: US 2025/0323295 A1
(43) Pub. Date: Oct. 16, 2025

(54) MASS AIR FLOW SENSOR FAILURE DETECTION AND MANAGEMENT IN AVIATION

(71) Applicant: ZEROAVIA, INC., Hollister, CA (US)

(72) Inventors: Stephen LAWES, Hollister, CA (US); Asif Mohammad SADIK, Hollister, CA (US); Aritra DALAL, Hollister, CA (US)

(21) Appl. No.: 19/174,887

(22) Filed: Apr. 9, 2025

(30) Foreign Application Priority Data
Apr. 15, 2024 (GB) 2405343.1

(51) Int. Cl. H01M 8/04664; G01F 25/10; H01M 8/0438; H01M 8/04746

(52) U.S. Cl. CPC H01M 8/04686; H01M 8/04425; H01M 8/04776; G01F 25/10; H01M 2250/20

(57) ABSTRACT

A method and system of detecting mass air flow (MAF) sensor failure on an aircraft includes at least one signal from a non-MAF sensor received by a controller of a fuel cell system having at least one MAF sensor. The signal received by the controller is analyzed relative to a compressor map to estimate mass air flow. A MAF sensor failure is detected based on the estimated mass air flow. When a MAF sensor failure is detected, a safe operating mode of the fuel cell system may be activated to provide adequate power for operation of the aircraft to a safe landing while minimizing risk of damage to the fuel cell system.

### CROSS REFERENCE TO RELATED APPLICATION

This application claims benefit to UK Patent Application Serial No. 2405343.1, filed Apr. 15, 2024, the contents of which are incorporated herein.

### FIELD OF THE DISCLOSURE

The present disclosure relates to operational management of mass air flow sensors in aviation. The disclosure has particular utility in the case of detecting and managing failures in mass air flow sensors used in fuel cell systems, such as hydrogen fuel cells on board vehicles, including aircraft, and will be described in connection with such utility, although other utilities are contemplated.

### BACKGROUND AND SUMMARY

This section provides background information related to the present disclosure which is not necessarily prior art. This section provides a general summary of the disclosure and is not a comprehensive disclosure of its full scope or all its features.

A fuel cell is an electrochemical cell that converts chemical energy into electrical energy by spontaneous electrochemical reduction-oxidation (redox) reactions. Fuel cells include an anode and a cathode separated by an ionically conductive electrolyte. During operation, a fuel (e.g., hydrogen) is supplied to the anode, and an oxidant (e.g., oxygen or air) is supplied to the cathode. The fuel is oxidized at the anode, producing positively charged ions (e.g., hydrogen ions) and electrons. The positively charged ions travel through the electrolyte from the anode to the cathode, while the electrons simultaneously travel from the anode to the cathode outside the cell via an external circuit, which produces an electric current. The oxidant supplied to the cathode is reduced by the electrons arriving from the external circuit and combines with the positively charged ions to form water. The reaction between oxygen and hydrogen is exothermic, generating heat that must be removed from the fuel cell.

Fuel cells may be used as power sources for electric motors of electric vehicles and hybrid electric vehicles, including aircraft. In such applications, fuel cells oftentimes are arranged in stacks of multiple cells and connected in a series or parallel arrangement to achieve a desired power and output voltage.

In many applications, and, in particular, in the use of fuel cells to power aircraft, fuel cells utilize inlet guide vanes (IGVs) to regulate the flow of oxidant to the cathode. These IGVs allow the air flow and pressure of the oxidant entering the compressor to be controlled to specific levels, and the levels of air flow can be monitored. In many instances, variable IGVs can be used to modulate the air flow and pressure on the cathode, where changes to the position of guide vanes at the inlet of a compressor can be made to achieve the desired air flow and pressure on the cathode.

Fuel cells rely on mass air flow (MAF) sensors to correctly set positions of the IGVs to control reactions in the fuel cells. However, MAFs are inherently unreliable. They often are susceptible to contaminants from the surrounding environment being carried with air flow to the MAFs, which can cause clogging or otherwise impact performance. If a MAF fails, incorrect readings of the air flow and pressure are likely to be sensed, which may result in incorrect IGV commands or other incorrect operating parameters for the fuel cell. These errors can lead to interruptions in power generation or permanent damage to the fuel cell. In an aircraft, the constant and controllable supply of power is critical to safe flight. Interruptions in power generation or permanent damage to a fuel cell can result in significant operational problems, including damage to the aircraft and safety risks to the occupants of the aircraft and others.

To prevent interruptions in power or operational problems to aircraft due to MAF sensor failures, it is possible to detect MAF sensor failure on an aircraft using one or more signals from non-MAF sensors, such as sensors responsive to various operating conditions of the fuel cell. The signal or signals from non-MAF sensors can be analyzed relative to an operating map that models the performance of the compressor upstream of the fuel cell. An estimate of the mass air flow is synthesized from analysis of the signal(s), which can be used to detect a failure within the MAF sensor.

The use of the compressor map, in combination with non-MAF sensors signals, such as signals indicating a compressor RPM, pressure, or temperature, can accurately detect a MAF sensor failure since the compressor map can identify MAF values which do not correlate with values provided by the MAF sensor itself. When a MAF sensor failure is detected, a safe system response can be initiated, such as by placing the fuel cell system in limp mode and/or by transmitting warnings or messages concerning the MAF sensor failure.

In one embodiment, the compressor map is pre-loaded as a lookup table, which may be derived from known data.

In another embodiment, the compressor map is developed dynamically from data gained from operating the system over time.

In another embodiment, in the event of a MAF sensor failure, the fuel cell system can be placed in a low power setting, referred to as “limp mode”, which is a safe operating condition which provides adequate power for operation of the aircraft to a safe landing while minimizing risk of damage to the fuel cell or associated equipment.

In one embodiment, the synthetic MAF estimate derived from the non-MAF sensors is used to control the position of the IGVs in limp mode, where the bounds on IGV actuation are dictated to maintain the system in limp mode. During limp mode, other control parameters, including H₂ flow rate, backpressure, and others, may be adjusted to ensure safe operation of the fuel cell system and aircraft.

In another embodiment, in a transition to limp mode, the IGVs and backpressure valves are mechanically locked, such as by using springs, into a known position to maintain a known mass flow rate for a given altitude and airspeed of the aircraft.

In another embodiment, IGVs may be mechanically locked if an error is detected in the IGV actuation and sensing. Such a failure could also be detected by a disagreement between measured and predicted MAF values, allowing for hysteresis and expected time- and condition-based deviations, and could be dispositioned by having the IGVs mechanically lock to a known, fixed position.

In another embodiment, in the event of a detected MAF failure, an electronic message or warning is used to notify the pilot that the aircraft will enter limp mode. A delay timer or similar mechanism may be used. The system would permit the pilot to override limp mode in the event that additional power is needed, which would also display warnings regarding damage to the fuel cell system to the pilot. In some embodiments, warnings may include information about minor damage and critical damage based on uncertainty in the estimated MAF based on operating condition. In limp mode, hydrogen flow could be controlled, as well as hydrogen pressure, in order to match reduced air flow.

The present disclosure can be viewed as providing methods of detecting MAF sensor failure on an aircraft. In this regard, one embodiment of such a method, among others, can be broadly summarized by the following steps: receiving, by a controller of a fuel cell system having at least one MAF sensor, at least one signal from a non-MAF sensor; analyzing the at least one signal received by the controller relative to a compressor map to estimate mass air flow; and detecting a MAF sensor failure based on the estimated mass air flow.

In one example, the at least one signal from the non-MAF sensor has signal data corresponding to at least one of: hydrogen concentration sensors providing a depletion rate, fuel cell voltage, fuel cell current, lift, drag, or torque values on IGVs, or compressor torque.

In another example, the at least one signal from the non-MAF sensor has signal data corresponding to at least one of: airspeed, pitot tube pressure rise, ambient pressure, ambient density, ambient temperature, compressor revolutions per minute (RPM), temperature on each side of an intercooler, pressure on each side of the intercooler, compressor inlet and outlet temperatures, compressor inlet and outlet pressures, fuel cell intake temperature, fuel cell intake pressure, humidity of cathode inlet and exhaust, oxygen content of cathode exhaust, power demand from a fuel cell, or oxygen and hydrogen consumption rate.

In yet another example, analyzing the at least one signal received by the controller relative to the compressor map further comprises analyzing the at least one signal relative to a tolerance range of the compressor map.

In another example, the method includes preloading the compressor map as a lookup table.

In yet another example, the method includes developing the compressor map from data gained from operation of the fuel cell system.

In another example, a map of error conditions of the fuel cell system is developed and the at least one signal is analyzed relative to the map of error conditions.

In yet another example, after detecting a MAF sensor failure, the fuel cell system is operated in limp mode, wherein in limp mode, IGVs and backpressure valves of the fuel cell system of the aircraft are locked.

In this example, one or more sensor values of the non-MAF sensor are used to set operational parameters of the fuel cell system in limp mode.

In this example, operational parameters are adjusted during limp mode, wherein the operational parameters include at least one of: a hydrogen flow rate and a position of backpressure valves.

In yet another example, a message is transmitted to aircraft personnel, indicating limp mode operation of the fuel cell system.

In this example, when limp mode operation of the fuel cell system is manually overridden, and a warning message of operational risks of non-limp mode operation of the fuel cell system is provided.

In yet another example, mass air flow through a compressor of the fuel cell system of the aircraft is controlled by making adjustments to a position of the IGVs.

The present disclosure can also be viewed as providing a system of detecting MAF sensor failure on an aircraft. Briefly described, in architecture, one embodiment of the system, among others, can be implemented as follows. A fuel cell system has at least one MAF sensor. A controller of the fuel cell system receives at least one signal from a non-MAF sensor, wherein the controller analyzes the at least one signal relative to a compressor map to estimate mass air flow, and detects a MAF sensor failure based on the estimated mass air flow.

In one example, the at least one signal from the non-MAF sensor has signal data corresponding to at least one of: hydrogen concentration sensors providing a depletion rate, fuel cell voltage, fuel cell current, lift, drag, or torque values on IGVs, or compressor torque.

In another example, the at least one signal from the non-MAF sensor has signal data corresponding to at least one of: airspeed, pitot tube pressure rise, ambient pressure, ambient density, ambient temperature, compressor RPM, temperature on each side of an intercooler, pressure on each side of the intercooler, compressor inlet and outlet temperatures, compressor inlet and outlet pressures, fuel cell intake temperature, fuel cell intake pressure, humidity of cathode inlet and exhaust, oxygen content of cathode exhaust, power demand from a fuel cell, or oxygen and hydrogen consumption rate.

In yet another example, the at least one signal received by the controller is analyzed relative to a tolerance range of the compressor map.

In another example, the compressor map is preloaded as a lookup table.

In yet another example, the compressor map is developed from data gained from operation of the fuel cell system.

In yet another example, the at least one signal is analyzed relative to a map of error conditions.

In another example, the fuel cell system is operated in limp mode after detecting a MAF sensor failure, wherein in limp mode, IGVs and backpressure valves of the fuel cell system of the aircraft are locked.

In this example, operational parameters of the fuel cell system in limp mode are set using one or more sensor values of the non-MAF sensor.

In this example, operational parameters are adjusted during limp mode, wherein the operational parameters include at least one of: a hydrogen flow rate and a position of backpressure valves.

In another example, a message is transmitted to aircraft personnel, indicating limp mode operation of the fuel cell system.

In this example, when limp mode operation of the fuel cell system is manually overridden, a warning message of operational risks of non-limp mode operation of the fuel cell system is provided.

In another example, mass air flow through a compressor of the fuel cell system of the aircraft is controlled by making adjustments to a position of the IGVs.

According to aspect A of the present invention there is provided a method of detecting mass air flow (MAF) sensor failure on an aircraft, the method comprising the steps of:
receiving, by a controller of a fuel cell system having at least one MAF sensor, at least one signal from a non-MAF sensor;
analyzing the at least one signal received by the controller relative to a compressor map to estimate mass air flow; and
detecting a MAF sensor failure based on the estimated mass air flow.

Preferably the at least one signal from the non-MAF sensor has signal data corresponding to at least one of: hydrogen concentration sensors providing a depletion rate, fuel cell voltage, fuel cell current, lift, drag, torque values on inlet guide vanes (IGVs), or compressor torque.

Preferably the at least one signal from the non-MAF sensor has signal data corresponding to at least one of: airspeed, pitot tube pressure rise, ambient pressure, ambient density, ambient temperature, compressor revolutions per minute (RPM), temperature on each side of an intercooler, pressure on each side of the intercooler, compressor inlet and outlet temperatures, compressor inlet and outlet pressures, fuel cell intake temperature, fuel cell intake pressure, humidity of cathode inlet and exhaust, oxygen content of cathode exhaust, power demand from a fuel cell, or oxygen and hydrogen consumption rate.

Preferably analyzing the at least one signal received by the controller relative to the compressor map further comprises analyzing the at least one signal relative to a tolerance range of the compressor map.

Preferably the method further comprises one or more of the following:
preloading the compressor map as a lookup table;
developing the compressor map from data gained from operation of the fuel cell system; or
developing a map of error conditions of the fuel cell system and analyzing the at least one signal relative to the map of error conditions.

Preferably after detecting a MAF sensor failure, operating the fuel cell system in limp mode, wherein, in limp mode, IGVs and backpressure valves of the fuel cell system of the aircraft are locked.

Preferably the method further comprises using one or more sensor values of the non-MAF sensor to set operational parameters of the fuel cell system in limp mode, and optionally further comprising adjusting operational parameters during limp mode, wherein the operational parameters include at least one of: a hydrogen flow rate and a position of backpressure valves.

Preferably the method further comprises transmitting a message to aircraft personnel, indicating limp mode operation of the fuel cell system, and optionally further comprising:
manually overriding limp mode operation of the fuel cell system; and
providing a warning message of operational risks of non-limp mode operation of the fuel cell system.

Preferably the method further comprises controlling mass air flow through a compressor of the fuel cell system of the aircraft by making adjustments to a position of the IGVs.

According to aspect B of the present invention there is provided a system of detecting mass air flow (MAF) sensor failure on an aircraft comprising the method of aspect A of the present invention.

According to aspect C of the present invention there is provided a system of detecting mass air flow (MAF) sensor failure on an aircraft comprising:
a fuel cell system having at least one MAF sensor;
a controller of the fuel cell system receiving at least one signal from a non-MAF sensor, further comprising using the method of aspect A of the present invention.

According to aspect D of the present invention there is provided a system of detecting mass air flow (MAF) sensor failure on an aircraft comprising:
a fuel cell system having at least one MAF sensor; and
a controller of the fuel cell system receiving at least one signal from a non-MAF sensor, wherein the controller analyzes the at least one signal relative to a compressor map to estimate mass air flow and detects a MAF sensor failure based on the estimated mass air flow.

Preferably the at least one signal from the non-MAF sensor has signal data corresponding to at least one of: hydrogen concentration sensors providing a depletion rate, fuel cell voltage, fuel cell current, lift, drag, torque values on inlet guide vanes (IGVs), or compressor torque.

Preferably the at least one signal from the non-MAF sensor has signal data corresponding to at least one of: airspeed, pitot tube pressure rise, ambient pressure, ambient density, ambient temperature, compressor revolutions per minute (RPM), temperature on each side of an intercooler, pressure on each side of the intercooler, compressor inlet and outlet temperatures, compressor inlet and outlet pressures, fuel cell intake temperature, fuel cell intake pressure, humidity of cathode inlet and exhaust, oxygen content of cathode exhaust, power demand from a fuel cell, or oxygen and hydrogen consumption rate.

Preferably the system further comprises one or more of the following:
wherein the at least one signal received by the controller is analyzed relative to a tolerance range of the compressor map;
wherein the compressor map is preloaded as a lookup table; or
wherein the compressor map is developed from data gained from operation of the fuel cell system.

Preferably the system further comprises a map of error conditions of the fuel cell system, wherein the at least one signal is analyzed relative to the map of error conditions.

Preferably the fuel cell system is operated in limp mode after detecting a MAF sensor failure, wherein, in limp mode, IGVs and backpressure valves of the fuel cell system of the aircraft are locked.

Preferably operational parameters of the fuel cell system in limp mode are set using one or more sensor values of the non-MAF sensor.

Preferably operational parameters are adjusted during limp mode, wherein the operational parameters include at least one of: a hydrogen flow rate and a position of backpressure valves.

Preferably the system further comprises a message transmitted to aircraft personnel, indicating limp mode operation of the fuel cell system.

Preferably when limp mode operation of the fuel cell system is manually overridden, a warning message of operational risks of non-limp mode operation of the fuel cell system is provided.

Preferably mass air flow through a compressor of the fuel cell system of the aircraft is controlled by making adjustments to a position of the IGVs.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

Further features and advantages of the disclosure will be seen in the following detailed description, taken in conjunction with the accompanying drawings. The drawings described herein are for illustrative purposes only of selected embodiments and not all possible implementations and are not intended to limit the scope of the present disclosure.

In the drawings:

FIG. 1 is a diagrammatical flow illustration of a system for detecting MAF sensor failure on an aircraft, in accordance with the present disclosure;

FIG. 2 is a diagrammatical illustration of a fuel cell system used by a system for detecting MAF sensor failure on an aircraft, in accordance with the present disclosure;

FIG. 3 is a flowchart illustrating a method of detecting MAF sensor failure on an aircraft in accordance with the present disclosure; and

FIG. 4 is a flowchart illustrating a detailed method of detecting MAF sensor failure on an aircraft in accordance with the present disclosure.

### DETAILED DESCRIPTION

Example embodiments will now be described more fully with reference to the accompanying drawings. Example embodiments are provided so that this disclosure will be thorough and will fully convey the scope to those who are skilled in the art. Numerous specific details are set forth such as examples of specific components, devices, and methods to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having” are inclusive and therefore specify the presence of stated features, integers, steps, operations, elements, components, and/or groups, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers, and/or sections, these elements, components, regions, layers, and/or sections should not be limited by these terms. These terms may be only used to distinguish one element, component, region, layer or section from another element, component, region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

To improve over the shortcomings in the industry, the present disclosure is directed to methods and systems for detecting MAF sensor failure on an aircraft using at least one signal from a non-MAF sensor. This signal can be analyzed relative to a compressor map to estimate mass air flow, which can indicate or be used to detect a failure within the MAF sensor. The use of a compressor map, in combination with non-MAF sensor signals, such as signals indicating a compressor RPM, pressure, or temperature, can be used to accurately detect a MAF sensor failure. When a MAF sensor failure is detected, a safe system response can be initiated, such as by placing the fuel cell system in limp mode and/or by transmitting warnings or messages concerning the MAF sensor failure.

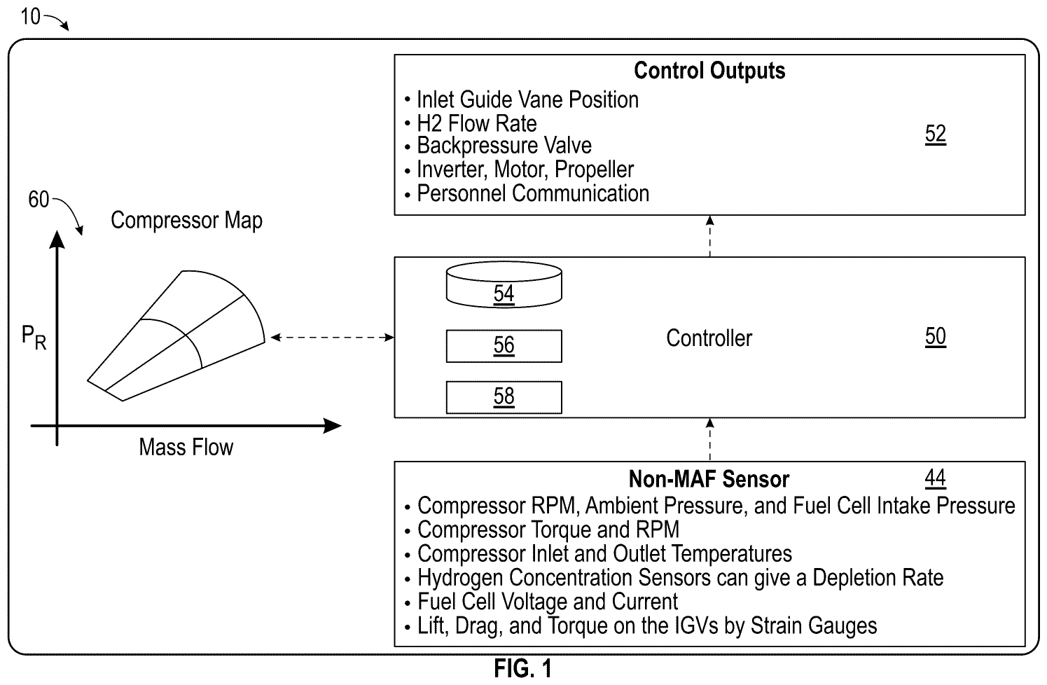

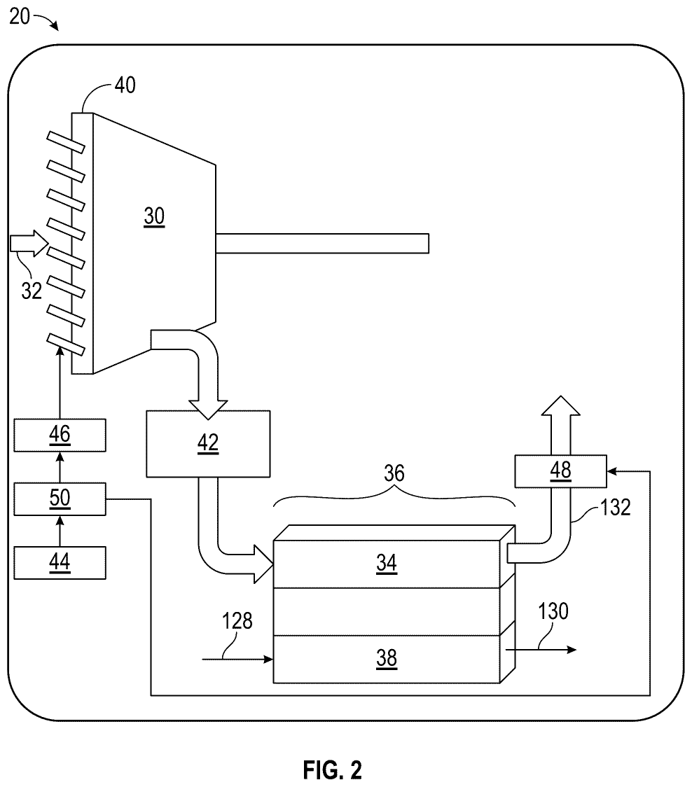

FIG. 1 is a diagrammatical flow illustration of a system 10 for detecting MAF sensor failure on an aircraft and FIG. 2 is a diagrammatical illustration of a fuel cell system 20 used by the system 10 for detecting MAF sensor failure on an aircraft, in accordance with the present disclosure. Relative to FIGS. 1-2 together, as shown, an aircraft or similar vehicle has a fuel cell system 20 which includes components for operation of the fuel cell system 20 to provide power to the aircraft and components for control of the fuel cell system 20. FIG. 2 depicts operational components of the fuel cell system 20, including a compressor 30 which intakes mass air flow 32 which is supplied to the cathode 34 of the fuel cell 36. Hydrogen 128 is supplied to the anode 38 of the fuel cell 36. The cathode 34 has a cathode exhaust 132 on an outlet side thereof and the anode 38 has a hydrogen exhaust 130 on an outlet side thereof.

The air flow into the fuel cell system 20 is primarily controlled by the IGVs 40 positioned on an intake side of the compressor 30. In nominal operation, the position of the IGVs 40 is governed by a feedback control system, based on the measured mass air flow using a dedicated MAF sensor 42. In order to maintain nominal operation of a fuel cell 36, the mass of air flowing to the cathode 34 should be regulated to within approximately 5% of a target value. In the event of a MAF sensor failure, it is not possible to achieve an accurate reading of the air flow through the compressor 30 based on the MAF sensor 42, such that it is not always possible to maintain the mass of the air flowing to the cathode 34 within the 5% range of the desired air flow.

In the event a MAF sensor 42 fails and the air flow is outside of the level desired, the fuel cell 36 can be damaged or operational performance of the fuel cell system 20 can be negatively affected. For instance, too much air flow can dry out the membranes of cathode 34, while too little air reduces output power of the fuel cell 36, which can reduce compressor 30 RPM, potentially further reducing power to the aircraft. Damage to the fuel cell 36 resulting from a MAF sensor 42 failure may necessitate additional maintenance or replacement. Failure of a fuel cell 36 in an aircraft, resulting from MAF sensor 42 failure in flight, poses a safety risk to occupants of the aircraft.

The system 10 detects a MAF sensor 42 failure on an aircraft by receiving at least one signal from one or more non-MAF sensors 44 in a controller 50 of the fuel cell system. Controller 50 analyzes the at least one signal from the non-MAF sensors 44 relative to a compressor map 60 of the fuel cell system 20 to estimate mass air flow. This estimate of the mass air flow through compressor 30 can be understood as a synthetic mass air flow estimate value, which can be compared or correlated with a reading of MAF sensor 42. The synthetic mass air flow estimate is a value calculated using the compressor map 60 and sensor readings from non-MAF sensors 44, and without direct measurement of mass air flow from MAF sensor 42. If there is a deviation between the synthetic mass air flow estimate value and a value provided by MAF sensor 42, where the deviation exceeds a threshold or tolerance which could occur in standard operation, it can be determined that a MAF sensor 42 failure has occurred.

FIG. 1 illustrates components for control of fuel cell system 20, including controller 50, which may be a computerized device in communication with components of fuel cell system 20, including sensors used in fuel cell system 20, as well as other systems within an aircraft. Controller 50 has various input/output capabilities to receive data and output data. As shown in FIG. 1, controller 50 may have a module which receives inputs from non-MAF sensors 44, and outputs signals, messages, or other data through a control output module 52. Data processed in controller 50 may be stored within one or more databases 54, with instructions stored in one or more memories 56, including non-transitory memories. One or more processors 58 may be used to execute programs and instructions to perform various functions.

The compressor map 60 may be understood as compiled data on performance or proper operating conditions of compressor 30. It may include a chart or table which depicts various characteristics of compressor 30. Compressor map 60 may provide data in two or more dimensions, such as in a three-dimensional table, as depicted in FIG. 1. While compressor map 60 may be capable of providing various types of data about compressor 30, as is shown in FIG. 1, compressor map 60 of system 10 may indicate the mass flow of air through compressor 30 as related to the pressure ratio (PR) of compressor 30. The pressure ratio, PR, may be determined from pressures immediately in front of and behind the compressor, or at the compressor inlet and outlet. It is noted that compressor map 60 may be preloaded into database 54 of controller 50 as a lookup table, or it may be developed from data gained from operation of fuel cell system 20, such as data compiled from operation over a period of time.

Non-MAF sensors 44 may include any one or more of numerous types of sensors sensing data relative to fuel cell system 20 and outputting signals with the sensed data. For example, non-MAF sensors 44 may be one or more hydrogen concentration sensors providing a depletion rate and/or a trend thereof, or sensors providing a fuel cell voltage or a fuel cell current which give a measure of oxygen and hydrogen consumption rate and/or a trend thereof, or lift, drag, and torque values and trends on the IGVs 40 measured by strain gauges, which, when used in conjunction with compressor map 60, may be used to estimate mass air flow. Non-MAF sensors 44 may also include sensors which provide data relating to airspeed and related pitot tube pressure rise and/or a trend thereof, ambient pressure, ambient density, or ambient temperature and/or a trend thereof, compressor torque and RPM and/or a trend thereof, temperature or pressure on each side of an intercooler, if used, compressor inlet and outlet temperatures or pressures and/or trends thereof, fuel cell intake temperature or pressure and/or a trend thereof, humidity of cathode inlet and exhaust and/or a trend thereof, oxygen content of cathode exhaust and/or a trend thereof, power demand from the fuel cell and/or a trend thereof, or oxygen and hydrogen consumption rate.

It is further noted that any combination of these non-MAF sensors 44 may be used in conjunction with one another, in any combination. This may include situations where multiple sensed values are used to determine the synthetic mass air flow estimate value, or where single sensed values are used. Additionally, it is noted that other types of sensed data from fuel cell system 20 or the aircraft beyond which are explicitly disclosed herein may also be used to determine the synthetic mass air flow estimate value.

The sensor measurements from non-MAF sensors 44 may be constrained by limitations on accuracy and time response. The dynamic response of compressor 30 is 1-100 msec. For the humidity sensor, the asymmetric wetting rate is greater than the drying rate, up to 90 sec T95 response. Asymmetry will be greater at low temperatures and minimal at >100° C. Thermal MAF sensors can be confused by sudden changes in ambient temperature, making it more attractive to measure heat transfer (delta T*specific heat). A tolerance of disagreement or tolerance range may be established so that if MAF sensor 42 reading deviates from the predicted region beyond this tolerance, there is reason to suspect MAF sensor 42 has experienced a failure. The tolerance range may be derived from data within compressor map 60, or from other data. Additionally, a map of error conditions of fuel cell system 20 may be established, and the signal(s) from non-MAF sensors 44 may be analyzed relative to this map of error conditions.

In the event of a MAF sensor 42 failure, system 10 may be placed in a “limp mode”, which may be understood as a safe operating mode of the fuel cell system 20 which provides adequate power for operation of the aircraft to a safe landing while minimizing risk of damage to fuel cell 36 or associated equipment in fuel cell system 20. In limp mode, IGVs 40 and backpressure valves 48 of fuel cell system 20 of the aircraft are locked in a particular position. For example, IGVs 40 may be mechanically locked with an IGV actuator 46, which may include an electromechanical or mechanical component, such as a spring, to lock IGV 40 in a particular position. The mass air flow through compressor 30 may be controlled by making adjustments to a position of IGVs 40. For example, the synthetic mass air flow estimate value may be used to control the position of IGVs 40 in limp mode, where the bounds on IGV actuation are dictated to maintain system 10 in limp mode.

In the transition to limp mode, IGVs 40 and backpressure valves 48 may be mechanically locked into a known position to maintain a known mass flow rate for a given altitude and airspeed of the aircraft, if an error is detected in IGV 40 actuation and sensing. Such a failure could also be detected by a disagreement between a sensed air flow from MAF sensor 42 and the synthetic mass air flow estimate value derived from compressor map 60 and non-MAF sensors 44, allowing for hysteresis and expected time-and-condition-based deviations. This would be dispositioned by having IGVs 40 mechanically lock to a known, fixed position.

During limp mode, control parameters may be adjusted to ensure safe operation of fuel cell system 20 and the aircraft. The operational parameters of fuel cell system 20 in limp mode may be set or determined using one or more sensor values of non-MAF sensors 44, the synthetic mass air flow estimate value derived from compressor map 60 and non-MAF sensors 44, or from other data. In one example, the operational parameters, which may be adjusted, include a hydrogen flow rate and/or a position of backpressure valves 48 in order to match a reduced air flow of the aircraft.

System 10 may utilize a personnel communication module to allow communication to and from controller 50. For instance, in the event of a detected MAF sensor 42 failure, system 10 may transmit a warning or message to aircraft personnel through the communication module, such as to a pilot of the aircraft, a control tower, or other relevant aircraft personnel, where the warning or message indicates fuel cell system 20 is operating in limp mode. The warnings or messages may be any type of electronic or non-electronic communication, such as a textual message, an auditory or visual alarm, or any combination thereof.

System 10 may also provide the pilot or aircraft personnel with advance notification that limp mode will be entered, such as where a delay timer or similar mechanism is used to provide the pilot with a period of time before limp mode is activated. System 10 permits a pilot to override limp mode, such as, for instance, in the event that additional power is needed, e.g., to achieve a climb to assure passenger safety. Any override of limp mode may be accompanied by display warnings to the pilot or other personnel regarding operational risks, such as possible or actual damage to fuel cell system 20. These warnings may include information about the severity of actual or possible damage. For instance, the warnings may indicate minor damage is occurring or possible to occur, such as degradation of fuel cell 36. They may also warn of critical damage, such as, for instance, a failure of fuel cell 36. Any warning or indication of operational risks may be based on the synthetic mass air flow estimate value or an uncertainty in the synthetic mass air flow estimate value.

It is noted that system 10 utilizes readings from MAF sensor 42 as a comparison to the synthetic mass air flow estimate value derived from non-MAF sensors 44 and compressor map 60 to indicate MAF sensor 42 failure. However, it is also possible for system 10 to provide an indication of a MAF rate based on the synthetic mass air flow estimate value derived from non-MAF sensors 44 and compressor map 60 without a comparison to a reading from MAF sensor 42. For instance, in the event of a full disconnection of a MAF sensor 42 from fuel cell system 20, such as if a communication line is severed or MAF sensor 42 experiences a malfunction significant enough to cause it to cease all functionality, it is possible for system 10 to still generate the synthetic mass air flow estimate value from non-MAF sensors 44 and compressor map 60 to provide an indication of air flow. Thus, it may be possible to achieve a mass flow prediction without a dedicated MAF sensor 42.

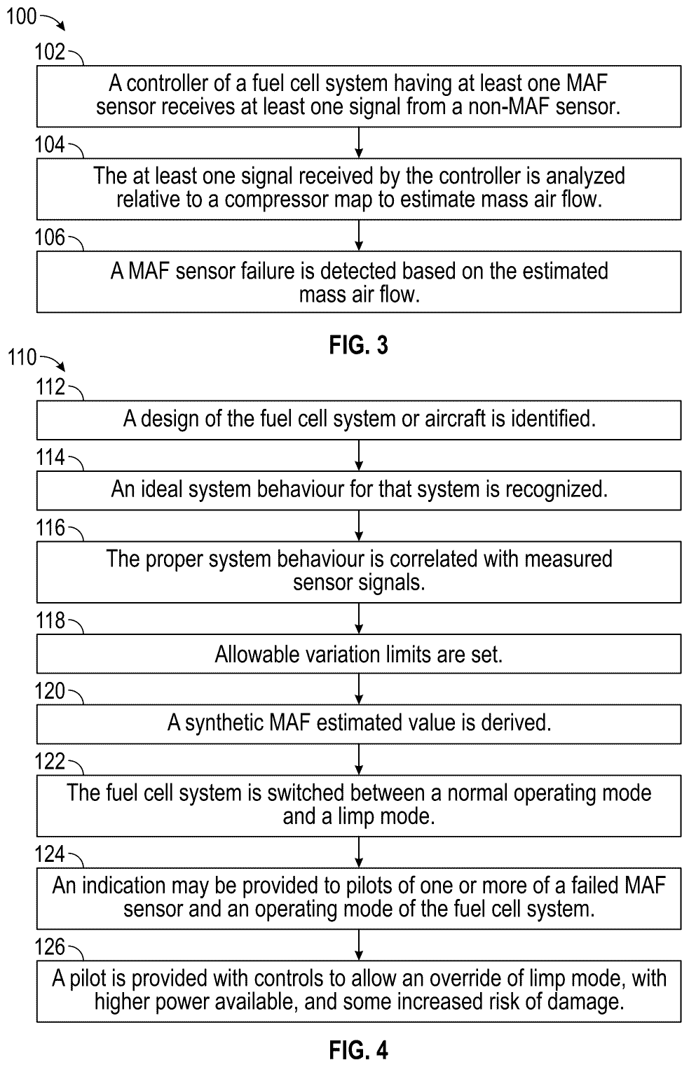

FIG. 3 is a flowchart 100 illustrating a method of detecting MAF sensor failure on an aircraft in accordance with the present disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrent or reverse order, depending on the functionality involved, as would be understood by those reasonably skilled in the art of the present disclosure.

As is shown by block 102, a controller of a fuel cell system having at least one MAF sensor receives at least one signal from non-MAF sensors. The at least one signal received by the controller is analyzed relative to a compressor map to estimate mass air flow, as shown in block 104. A MAF sensor failure is detected based on the estimated mass air flow, as indicated at block 106.

Any number of additional steps, functions, processes, or variants thereof may be included in the method, including any disclosed relative to any other figure of this disclosure. For instance, in one example, the at least one signal from the non-MAF sensors has signal data corresponding to at least one of: hydrogen concentration sensors providing a depletion rate, fuel cell voltage, fuel cell current, lift, drag, torque values on IGVs, or compressor torque. In another example, the at least one signal from the non-MAF sensors has signal data corresponding to at least one of: airspeed, pitot tube pressure rise, ambient pressure, ambient density, ambient temperature, compressor RPM, temperature on each side of an intercooler, pressure on each side of the intercooler, compressor inlet and outlet temperatures, compressor inlet and outlet pressures, fuel cell intake temperature, fuel cell intake pressure, humidity of cathode inlet and exhaust, oxygen content of cathode exhaust, power demand from a fuel cell, or oxygen and hydrogen consumption rate.

Analyzing the at least one signal received by the controller relative to the compressor map of the fuel cell system may include analyzing the at least one signal relative to a tolerance range of the compressor map. The compressor map may be preloaded as a lookup table, developed from data gained from operation of the fuel cell system, or derived or populated in another manner. Additionally, a map of error conditions of the fuel cell system may be developed where the at least one signal is analyzed relative to the map of error conditions.

The method may also include operating the fuel cell system in limp mode after detecting a MAF sensor failure. In limp mode, IGVs and backpressure valves of the fuel cell system of the aircraft are locked. One or more sensor values of the non-MAF sensors may be used set to operational parameters of the fuel cell system in limp mode, and operational parameters may be adjusted during limp mode. The operational parameters may include, for example, at least one of: a hydrogen flow rate and a position of backpressure valves. Additionally, a message may be transmitted to aircraft personnel, such as a pilot, control tower, or similar personnel, indicating limp mode operation of the fuel cell system. The aircraft personnel may choose to manually override limp mode operation of the fuel cell system, and, when this occurs, a warning message of operational risks of non-limp mode operation of the fuel cell system may be provided. The method may also include controlling mass air flow through a compressor of the fuel cell system of the aircraft by making adjustments to a position of the IGVs.

FIG. 4 is a flowchart 110 illustrating a detailed method of detecting MAF sensor failure on an aircraft in accordance with the present disclosure, which may allow implementation of the system 10 for any aircraft or fuel cell system. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrent or reverse order, depending on the functionality involved, as would be understood by those reasonably skilled in the art of the present disclosure.

As is shown by block 112, a design of the fuel cell system or aircraft is identified. The ideal system behavior for that system is recognized, such as through data which identifies system behavioral characteristics or parameters for a particular fuel cell system (block 114). The proper system behavior is correlated with measured sensor signals (block 116), and allowable variation limits are set (block 118). A synthetic MAF estimated value is derived (block 120) and the fuel cell system is switched between a normal operating mode and a limp mode (block 122). An indication may be provided to pilots of one or more of a failed MAF sensor and an operating mode of the fuel cell system, as shown at block 124. A pilot is provided with controls to allow an override of limp mode with higher power available and some increased risk of damage (block 126). Any number of additional steps, functions, processes, or variants thereof may be included in the method, including any disclosed relative to any other figure of this disclosure.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure. Various changes and advantages may be made in the above disclosure without departing from the spirit and scope thereof.

What is claimed is:

1. A method of detecting mass air flow (MAF) sensor failure on a vehicle, the method comprising the steps of:
receiving, by a controller of a fuel cell system having at least one MAF sensor, at least one signal from a non-MAF sensor;
analyzing the at least one signal received by the controller relative to a compressor map to estimate mass air flow; and
detecting a MAF sensor failure based on the estimated mass air flow, wherein the at least one signal from the non-MAF sensor has signal data corresponding to at least one of: hydrogen concentration sensors providing a depletion rate, fuel cell voltage, fuel cell current, lift, drag, torque values on inlet guide vanes (IGVs), or compressor torque.

2. The method of claim 1, wherein the at least one signal from the non-MAF sensor has signal data corresponding to at least one of: airspeed, pitot tube pressure rise, ambient pressure, ambient density, ambient temperature, compressor revolutions per minute (RPM), temperature on each side of an intercooler, pressure on each side of the intercooler, compressor inlet and outlet temperatures, compressor inlet and outlet pressures, fuel cell intake temperature, fuel cell intake pressure, humidity of cathode inlet and exhaust, oxygen content of cathode exhaust, power demand from a fuel cell, or oxygen and hydrogen consumption rate.

3. The method of claim 1, wherein analyzing the at least one signal received by the controller relative to the compressor map further comprises analyzing the at least one signal relative to a tolerance range of the compressor map.

4. The method of claim 1, further comprising one or more of the following:
preloading the compressor map as a lookup table;
developing the compressor map from data gained from operation of the fuel cell system; or
developing a map of error conditions of the fuel cell system and analyzing the at least one signal relative to the map of error conditions.

5. The method of claim 1, wherein, after detecting a MAF sensor failure, operating the fuel cell system in limp mode, wherein, in limp mode, IGVs and backpressure valves of the fuel cell system of the vehicle are locked.

6. The method of claim 5, further comprising using one or more sensor values of the non-MAF sensor to set operational parameters of the fuel cell system in limp mode.

7. The method of claim 6, further comprising adjusting operational parameters during limp mode, wherein the operational parameters include at least one of: a hydrogen flow rate and a position of backpressure valves.

8. The method of claim 5, further comprising transmitting a message to vehicle personnel, indicating limp mode operation of the fuel cell system.

9. The method of claim 8, further comprising:
manually overriding limp mode operation of the fuel cell system; and
providing a warning message of operational risks of non-limp mode operation of the fuel cell system.

10. The method of claim 1, further comprising controlling mass air flow through a compressor of the fuel cell system of the vehicle by making adjustments to a position of the IGVs.

11. A system of detecting mass air flow (MAF) sensor failure on a vehicle comprising:
a fuel cell system having at least one MAF sensor; and
a controller of the fuel cell system receiving at least one signal from a non-MAF sensor, wherein the controller analyzes the at least one signal relative to a compressor map to estimate mass air flow and detects a MAF sensor failure based on the estimated mass air flow, wherein the at least one signal from the non-MAF sensor has signal data corresponding to at least one of: hydrogen concentration sensors providing a depletion rate, fuel cell voltage, fuel cell current, lift, drag, torque values on inlet guide vanes (IGVs), or compressor torque.

12. The system of claim 11, wherein the at least one signal from the non-MAF sensor has signal data corresponding to at least one of: airspeed, pitot tube pressure rise, ambient pressure, ambient density, ambient temperature, compressor revolutions per minute (RPM), temperature on each side of an intercooler, pressure on each side of the intercooler, compressor inlet and outlet temperatures, compressor inlet and outlet pressures, fuel cell intake temperature, fuel cell intake pressure, humidity of cathode inlet and exhaust, oxygen content of cathode exhaust, power demand from a fuel cell, or oxygen and hydrogen consumption rate.

13. The system of claim 11, further comprising one or more of the following:
wherein the at least one signal received by the controller is analyzed relative to a tolerance range of the compressor map;
wherein the compressor map is preloaded as a lookup table; or
wherein the compressor map is developed from data gained from operation of the fuel cell system.

14. The system of claim 11, further comprising a map of error conditions of the fuel cell system, wherein the at least one signal is analyzed relative to the map of error conditions.

15. The system of claim 11, wherein the fuel cell system is operated in limp mode after detecting a MAF sensor failure, wherein, in limp mode, IGVs and backpressure valves of the fuel cell system of the vehicle are locked.

16. The system of claim 15, wherein operational parameters of the fuel cell system in limp mode are set using one or more sensor values of the non-MAF sensor.

17. The system of claim 16, wherein operational parameters are adjusted during limp mode, wherein the operational parameters include at least one of: a hydrogen flow rate and a position of backpressure valves.

18. The system of claim 15, further comprising a message transmitted to vehicle personnel, indicating limp mode operation of the fuel cell system.

19. The system of claim 18, wherein, when limp mode operation of the fuel cell system is manually overridden, a warning message of operational risks of non-limp mode operation of the fuel cell system is provided.

20. The system of claim 11, wherein mass air flow through a compressor of the fuel cell system of the vehicle is controlled by making adjustments to a position of the IGVs.
